(19) United States
(12) Patent Application Publication
(10) Pub. No.: US 2002/0065806 A1
(43) Pub. Date: May 30, 2002

(54) DHCP server and method for allocating IP address thereby

(75) Inventor: Won Sik Kim, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/995,660

(22) Filed: Nov. 29, 2001

(30) Foreign Application Priority Data
Nov. 29, 2000 (KR) 2000-71610

(51) Int. Cl. G06F 7/00

(52) U.S. Cl. 707/1

(57) ABSTRACT

A DHCP server and a method for allocating an IP address are disclosed. The DHCP server issues an ICMP ping packet when the DHCP server receives an IP address allocation request from a DHCP client. Then, the DHCP server determines whether another host having the IP address exists on a network by determining whether the ICMP ping reply is from the DHCP client requesting the IP address or from another DHCP client. Thereafter, the DHCP server allocates only IP addresses that are not under use. Therefore, even if the network is provided using the DHCP, there will not be any IP address collisions.

### BACKGROUND OF THE INVENTION

1. Field of the Invention

The present invention relates to a DHCP server and a method for allocating an IP address by a DHCP server.

2. Background of the Related Art

In general, the Dynamic Host Configuration Protocol (DHCP) server provides a function for transmitting configuration parameters to host servers using a TCP/IP protocol. The TCP/IP protocol has a message format based on the message format of a Bootstrap Protocol (BOOTP).

The DHCP is considered to be an upgrade version of the BOOTP. According to the DHCP, a client server, when booted, receives IP configuration information from the DHCP server, dynamically or statically. This allows a network manager to reduce trouble by providing one network setting to every host server. Also, the DHCP server permits an effective use of the limited number of IP addresses by allocating fewer IP addresses than the number of existing client servers.

With a dynamic allocation, if there is a configuration information request from a client, the network manager selects and allocates an IP address which is not presently allocated to other clients, within an IP address range (for an example, 100.1.1.1˜100.1.1.254) preset by the network manager. In this instance, the DHCP sever gives the client a right to use the IP address for a lease duration preset by the network manager, rather than an indefinite period.

With a static allocation, if there is a configuration information request from one client, the DHCP server makes sure a hardware address of the client exists in a table. The table pairs an IP address given by the network manager with the hardware address. The DHCP server permits the client to use the IP configuration information without a time limit, only when the hardware address is in the table.

FIG. 1 illustrates a state-transition diagram of a DHCP client. The DHCP client transmits a DHCP discover message after booting. In this instance, even if a proper DHCP offer message is obtained at the first attempt, the DHCP client transmits the DHCP discover message many times without taking the obtained DHCP offer message directly.

Ideally, there is no IP address collision problem even if a network is provided using the DHCP. However, in reality there are frequent IP address collisions for the following reasons.

First, the network manager may mistakenly cause the DHCP server to allocate, to a host, a fixed IP address already used by another host. In this case, the DHCP server mistakenly sets the fixed IP address already under use as an available IP address. This happens frequently, even though it should not.

Second, two or more DHCP servers may allocate the same IP address to respective DHCP clients. As with the first example, this case may occur due to a mistake of the network manager.

A third example involves a DHCP server that does not store an IP address allocation table in a non-volatile medium, such as non-volatile RAM, a hard disc, or an external Trivial File Transfer Protocol (FTP/TFTP) file. The server is re-booted after having previously allocated the IP addresses. Since the DHCP server has no current information on the previously allocated IP addresses, it may mistakenly reallocate a currently used IP address to another DHCP client, if the other DHCP client requests an IP address.

For example, assume a DHCP server that can allocate IP addresses from 10.1.1.1 to 10.1.1.5 has allocated IP addresses 10.1.1.1 and 10.1.1.2 to a first client host, having a MAC address 00:50:ce:18:85:6c, and a second client having a MAC address 00:60:97:2d:67:5d, respectively. If a third client host, having a MAC address 00:10:4b:1c:8a:d8, requests an IP address, the DHCP server allocates a new IP address 10.1.1.3 since the DHCP server knows that IP addresses 10.1.1.1, and 10.1.1.2 are allocated. Therefore, no problem occurs.

On the other hand, assume that the DHCP server is re-booted after IP addresses 10.1.1.1 and 10.1.1.2 have been allocated. In this instance, when the third client host requests the allocation of an IP address, the DHCP server may mistakenly allocate the IP address 10.1.1.1 to the third client host in duplication of the allocation to the first client host. This mistaken, duplicate allocation may occur becauce the DHCP server has no information on the allocation of the IP addresses made before the DHCP server was re-booted. In this instance, there is an IP address collision between the first client host and the third client host.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Accordingly, the present invention is directed to a DHCP server and a method for allocating an IP address by a DHCP server that substantially obviates one or more of the problems due to limitations and disadvantages of the related art.

Another object of the present invention is to provide a DHCP server and a method for allocating an IP address by a DHCP server that can prevent the duplicate allocation of an IP address.

Still another object of the present invention is to provide a DHCP server and a method for allocating an IP address by a DHCP server that can prevent an IP address collision, which can occur when a network is provided using the DHCP.

To achieve these and other advantages and in accordance with the purpose of the present invention, as embodied and broadly described, the DHCP server identifies the existence of another host using the IP address it intends to allocate on a network, using an Internet Control Message Protocol (ICMP) ping, before allocating the IP address to a requesting DHCP client. Then, the IP address is allocated to the DHCP client only when it has been determined that there is no other host having the same IP address.

In another aspect of the present invention, there is provided a DHCP server including an ICMP module for issuing an ICMP ping packet, according to an IP address allocation request from a DHCP client, and registering relevant event information on a DHCP ping entry; a determining module for determining whether a reply to the ICMP ping packet is from the DHCP client requesting the IP address allocation or from another DHCP client; and a first operation module for conducting a DHCP procedure using the registered event information, if the reply is from the DHCP client requesting the IP address allocation. If the reply is from a DHCP client other than the one requesting the IP address, the first operation module changes the registered event information through the ICMP module and issues a new ICMP ping packet.

In a further aspect of the present invention, there is provided a method for allocating an IP address by a DHCP server, including (a) issuing an ICMP ping packet and registering relevant event information on a DHCP ping entry, when an IP address allocation request is received from a DHCP client; (b) conducting a DHCP procedure using the registered event information and erasing the registered event information from the DHCP ping entry, when a reply to the packet is from the DHCP client requesting the IP address allocation; and (c) changing the event information registered on the DHCP ping entry and issuing a new ICMP ping packet, when the reply to the packet is from another DHCP client.

The objects of the invention may be achieved in whole or in part by a server, having an Internet Control Message Protocol (ICMP) module that issues a ping packet according to a received Internet Protocol (IP) address allocation request; a determining module that determines whether a reply to the issued ping packet came from a first client that requested the IP address allocation or from a second client; and a first operation module that allocates an IP address to the first client if the first client is determined to have sent the reply.

The objects of the invention may be achieved in whole or in part by a method of allocating an Internet Protocol (IP) address by a server, including issuing a ping packet according to a received IP address allocation request; determining whether a reply to the issued ping packet came from a first client that requested the IP address allocation or from a second client; and allocating the IP address to the first client, if the first client is determined to have sent the reply.

Thus, by using the ICMP ping at the DHCP server, the IP address collision which may occur in providing a network of the DHCP can be prevented.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates state-transitions of a DHCP client;

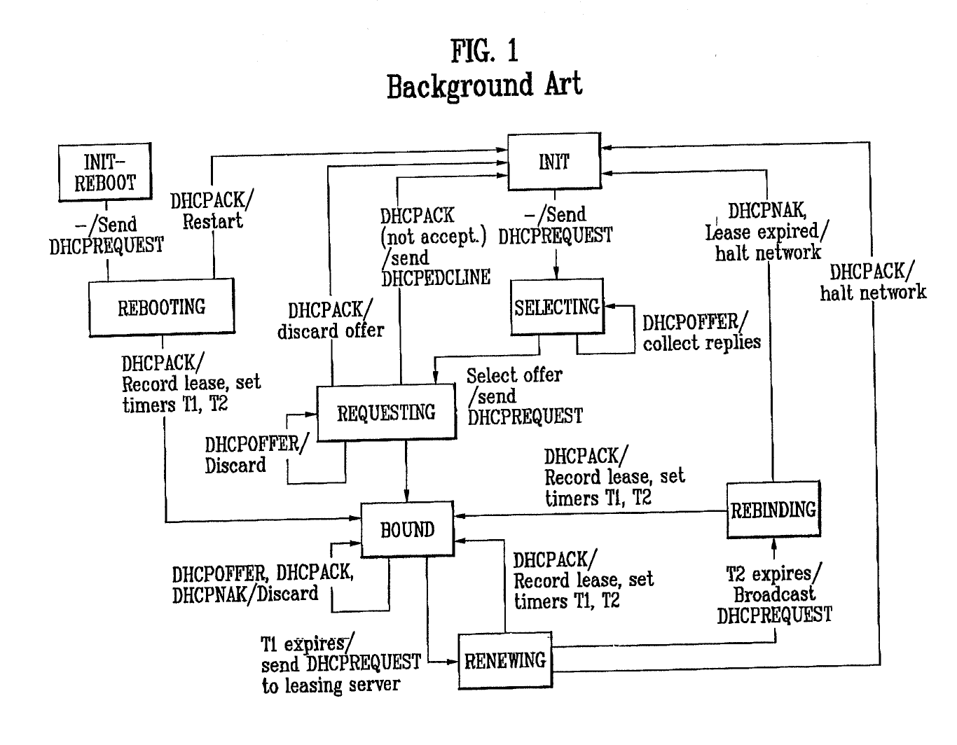

FIG. 2 illustrates a system of a DHCP server in accordance with a preferred embodiment of the present invention;

FIG. 3 illustrates a flow chart of a process for producing an ICMP ping packet, when a DHCP server is requested to allocate an IP address by a DHCP client;

FIG. 4 illustrates a flow chart of a process for determining whether a reply to an ICMP ping packet came from a DHCP client requesting the allocation of an IP address or from another client; and

FIG. 5 illustrates a flow chart of a process for progressing a DHCP procedure after a system timer loop preiodically confirms a DHCP ping entry.

It is to be understood that both the foregoing general description and the following detailed description are exemplary and explanatory and are intended to provide further explanation of the invention as claimed.

### DETAILED DESCRIPTION OF PREFERRED EMBODIMENTS

Reference will now be made in detail to the preferred embodiments of the present invention, examples of which are illustrated in the accompanying drawings.

If there is a DHCP discover message from one DHCP client, the DHCP server searches a static allocation table and a dynamic allocation free table in succession. The static allocation table has entries of combinations of an IP address and a hardware address, and the dynamic allocation free table has IP addresses available for allocation. The available IP addresses are set by a network manager.

The ICMP ping packet employed in the preferred embodiment of the invention will now be explained. The ping is an application program of the TCP/IP protocol. It provides verification of whether an IP data program can reach another host. A program for conducting the ping transmits a message, called as an ‘ICMP echo request,’ to a distant host and waits for a reply from the host. In other words, if the host that receives the ICMP echo request is in operation, the host will give a reply. Otherwise, the host will give no reply. As explained, the operational status of the distant host can be verified depending on whether a reply to the ICMP echo request is received.

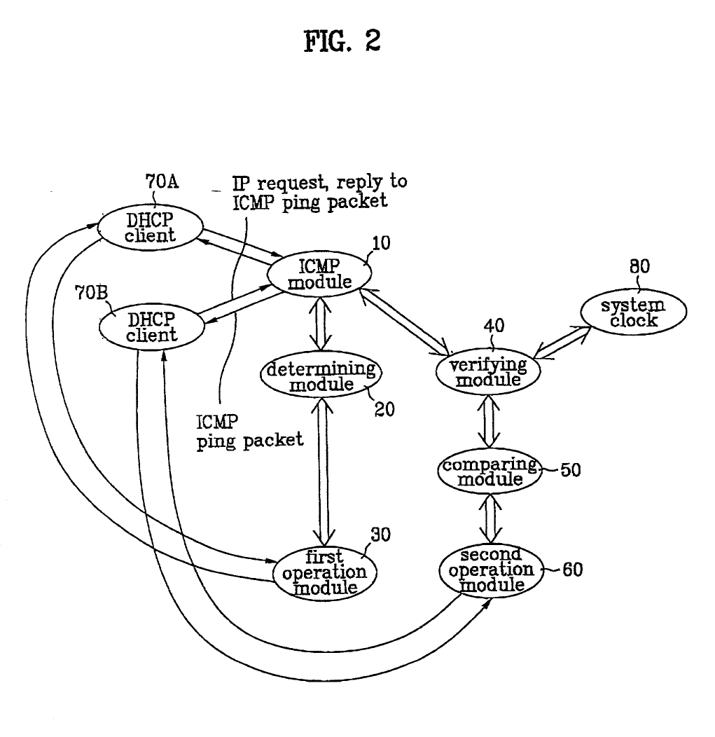

FIG. 2 illustrates a block diagram showing a system of a DHCP server in accordance with a preferred embodiment of the present invention. The DHCP server includes an ICMP module 10, a determining module 20, a first operation module 30, a verifying module 40, a comparing module 50, and a second operation module 60.

The ICMP module 10 issues the Internet Control Message Protocol (ICMP) ping packet according to an IP address allocation request from a DHCP client and registers relevant event information on a DHCP ping entry.

The determining module 20 determines whether the reply to the ICMP ping packet came from the DHCP client requesting the IP address allocation or from another DHCP client.

The first operation module 30 conducts a DHCP procedure using the registered event information, if the reply is from the DHCP client requesting the IP address allocation, and changes the registered event information through the ICMP module 10 and issues a new ICMP ping packet, if the reply is from another DHCP host.

The verifying module 40 conducts a system timer loop and verifies the event information registered on the DHCP ping entry, periodically.

The comparing module 50 compares an event occurrence time, of the event information registered in the DHCP entry, to an out time set at the DHCP ping packet.

The second operation module 60 conducts the DHCP procedure using the registered event information and erases the event information from the DHCP ping entry, if the event occurrence time is older than the out time set at the DHCP ping packet. The determination of whether the event occurrence time is older is based on the comparison made by the comparing module 50.

In FIG. 2, reference symbols 70A and 70B are client servers and reference symbol 80 is a system clock device for providing system clocks.

The operation of the DHCP server will be explained with reference to FIGS. 6-8.

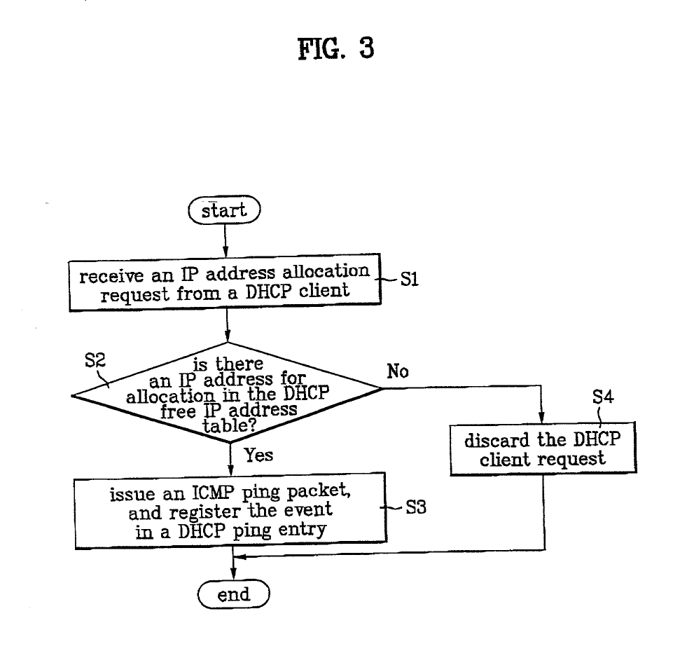

Referring to FIG. 3, upon receipt of an IP address allocation request from a DHCP client, the DHCP server issues an ICMP ping packet. The steps for issuing the ICMP ping packet are as follows.

The DHCP server receives the IP address allocation request from the DHCP client (step S1). Then, the DHCP server determines whether there is an IP address available from a DHCP free IP address table (step S2). If so, the DHCP server issues an ICMP ping packet and registers event information for the IP address on the DHCP ping entry (step S3). A completion of the registration implies that the DHCP server holds the IP address allocation request. If there is not an available IP address in the DHCP free IP address table, the DHCP server discards the IP address allocation request received from the DHCP client (step S4).

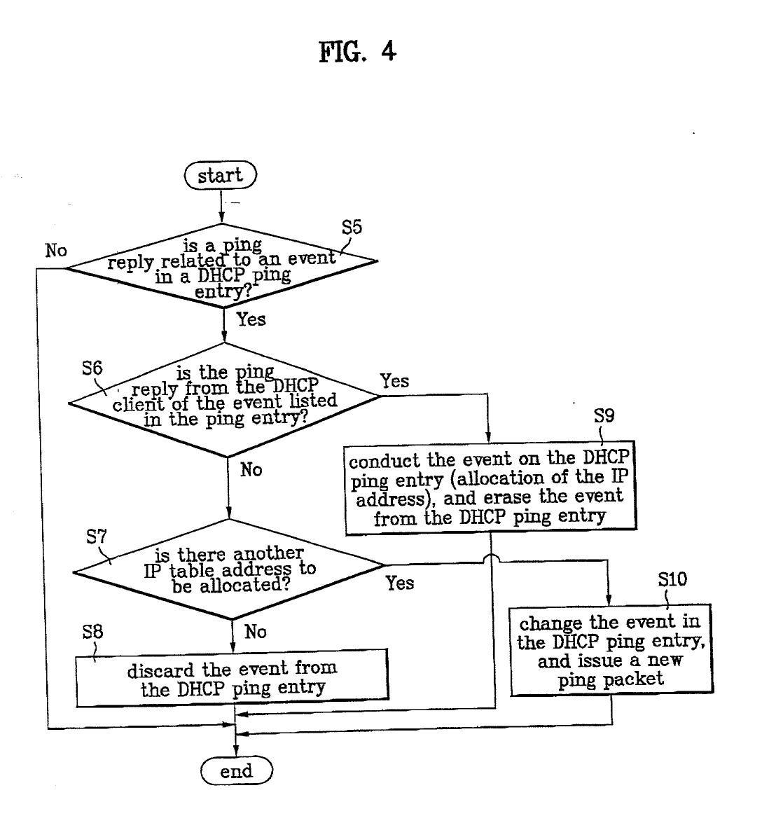

FIG. 4 illustrates the steps of a determining process carried out in a case where there is a reply to the ICMP ping packet. The determining module 20 of the DHCP server determines whether the reply to the ICMP ping packet came from the DHCP client requesting the IP address allocation or from another host (i.e., another DHCP client). The determining module 20 calls for the operation modules only when the reply to the ICMP ping packet is caused by the ICMP ping request or by a packet issued from the DHCP server. After the calling, the determining module 20 determines whether the reply to the ICMP ping request came from the DHCP client requesting the IP allocation or other hosts (i.e., other DHCP clients) (step S5).

As a result of the determination, if the reply to the ICMP ping request is from the DHCP client requesting the IP allocation, the determining module 20 determines that there is no other host (or DHCP client) having an IP address duplicated with the requested IP address on the network (step S6). Then, the first operation module 30 conducts a DHCP procedure using the event information registered on the DHCP ping entry (step S9). The DHCP procedure is a process for allocating the requested IP address to the DHCP client. After conducting the DHCP procedure, the first operation module 30 erases the event information from the DHCP ping entry (step S9).

On the other hand, if the reply to the ICMP ping request is not from the DHCP client requesting the IP address allocation, the ICMP module 10 obtains a new IP address from the DHCP free IP address table and issues a new ICMP ping packet (or request) (steps S7, S10). Then, the ICMP module 10 registers the issued new ICMP packet on the DHCP ping entry as new event information, on the one side, and erases the previous event information on the other side (step S10).

If there is no new IP address for allocation in the DHCP free IP table, the ICMP module 10 discards the IP address allocation request from the DHCP client (steps S7, S8).

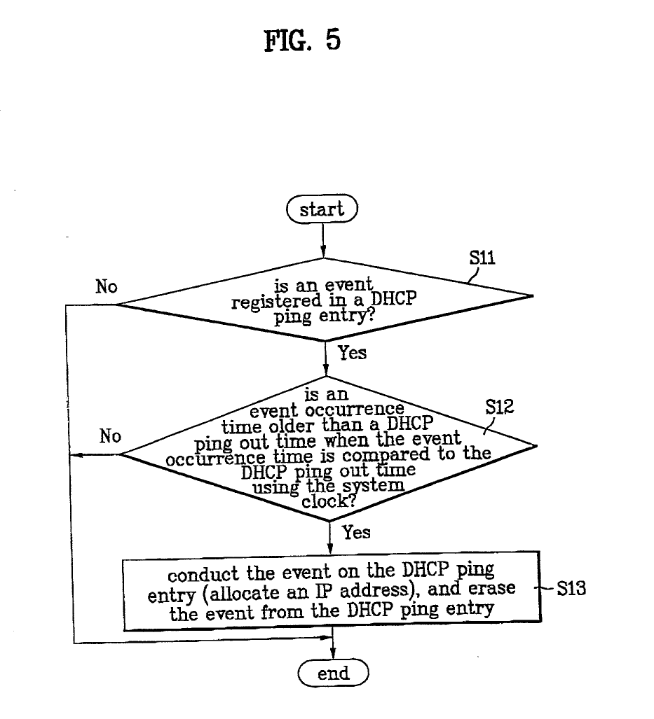

FIG. 5 illustrates another DHCP procedure according to a system timer loop. The verifying module 40 verifies the event information registered in the DHCP ping entry, as the system timer loop is operated periodically (step S11). The comparing module 50 searches registered event information for event information having an occurrence time older than an out time of the DHCP ping request, which the manager set already (step S12). If the event information, having an occurrence time older than the out time for the DHCP ping request, contains no reply to the DHCP ping request, the second operation module 60 progresses the DHCP procedure.

At first, the verifying module 40 operates the system timer loop to verify the presence of event information registered in the DHCP ping entry (step S11). If there is registered event information in the DHCP ping entry as a result of the operation, the comparing module 50 compares an event occurrence time in the event information and the out time, set at the DHCP ping request, using a system clock (step S12).

As a result of the comparison, if the occurrence time of the event information is older than the out time set at the DHCP ping request, the second operation module 60 determines that the event information contains no reply to the DHCP ping request. In other words, the second operation module 60 determines that there is no other host (or DHCP client) having an IP address duplicated with the IP address to be allocated to the network. Then, the second operation module 60 erases the event information from the DHCP ping entry (step S13).

As has been explained, when a DHCP server receives an IP address allocation request from a DHCP client, the DHCP server issues an ICMP ping packet of the requested IP address. Therefore, the existence of another host or hosts having the requested IP address on the network is verified in advance. Eventually, only one of the IP addresses not in use yet is allocated to the DHCP client. Accordingly, there is no collision of the IP addresses in providing a DHCP network.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A Dynamic Host Configuration Protocol (DHCP) server, comprising:
an Internet Control Message Protocol (ICMP) module that issues an ICMP ping packet, based on an IP address allocation request from a DHCP client, and registers relevant event information in a DHCP ping entry;
a determining module that determines whether a reply to the ICMP ping packet came from the DHCP client requesting the IP address allocation or another DHCP client; and
a first operation module that conducts a DHCP procedure using the registered relevant event information, if the reply is from the DHCP client requesting the IP address allocation, and changes the registered relevant event information through the ICMP module and issues a new ICMP ping packet, if the reply is not from the DHCP client.

2. The DHCP server of claim 1, wherein the first operation module erases the registered relevant event information from the DHCP ping entry during the DHCP procedure.

3. The DHCP server of claim 1, wherein the DHCP procedure is a process for allocating a requested IP address to the DHCP client requesting the IP address.

4. The DHCP server of claim 1, further comprising:
a verifying module that conducts a system timer loop, the system timer loop is used to periodically verify the relevant event information registered in the DHCP ping entry;
a comparing module that compares an event occurrence time and an out time, which is set in the relevant event information registered in the DHCP ping entry; and
a second operation module that conducts the DHCP procedure using the registered relevant event information and erases the relevant event information from the DHCP ping entry, if the event occurrence time is older than the out time set in the corresponding DHCP ping entry.

5. The DHCP server of claim 4, wherein the DHCP procedure is a process for allocating a requested IP address to the DHCP client requesting the IP address.

6. The DHCP server of claim 4, wherein the second operation module erases the registered relevant event information from the DHCP ping entry during the DHCP procedure.

7. The DHCP server of claim 1, further comprising a system clock device that provides timing information to the DHCP server.

8. A method for allocating an Internet Protocol (IP) address by a Dynamic Host Configuration Protocol (DHCP) server, comprising:
issuing an Internet Control Message Protocol (ICMP) ping packet and registering relevant event information in a DHCP ping entry when an IP address allocation request is received from a DHCP client;
conducting a DHCP procedure using the registered relevant event information and erasing the registered relevant event information from the DHCP ping entry, when a reply to the ICMP ping packet is received from the DHCP client requesting the IP address allocation; and
changing the relevant event information registered in the DHCP ping entry and issuing a new ICMP ping packet, when the reply to the ICMP ping packet is from another DHCP client.

9. The method of claim 8, wherein the relevant event information includes the IP address, a Media Access Control (MAC) address of the DHCP client, and an event occurrence time.

10. The method of claim 8, further comprising discarding the IP address allocation request, received from the DHCP client, when there is no new IP address available for allocation in a DHCP free IP address table.

11. The method of claim 8, further comprising:
operating a system timer loop used to periodically verify the DHCP ping entry;
comparing an event occurrence time registered in the DHCP ping entry and a set DHCP ping out time; and
conducting the DHCP procedure using the registered relevant event information and erasing the relevant event information from the DHCP ping entry if the registered event occurrence time is older than the set DHCP ping packet out time.

12. The method of claim 11, wherein the relevant event information includes the IP address, a Media Access Control (MAC) address of the DHCP client, and the event occurrence time.

13. The method of claim 11, wherein the system timer loop is operated with a system clock device provided in the DHCP server.

14. A server, comprising:
an Internet Control Message Protocol (ICMP) module that issues a ping packet according to a received Internet Protocol (IP) address allocation request;
a determining module that determines whether a reply to the issued ping packet came from a first client that requested the IP address allocation or from a second client; and
a first operation module that allocates an IP address to the first client if the first client is determined to have sent the reply.

15. The server of claim 14, wherein the first operation module discards the IP address allocation request if the second client is determined to have sent the reply.

16. The server of claim 14, further comprising:
a comparing module that compares an event occurrence time stored by the ICMP module in a ping entry with an out time set in the ping packet; and
a second operation module that erases the ping entry if the event occurrence time is older that the out time.

17. The server of claim 14, further comprising a verifying module that repeatedly induces the server to determine whether the reply has been received.

18. A method of allocating an Internet Protocol (IP) address with a server, comprising:
issuing a ping packet according to a received IP address allocation request;
determining whether a reply to the issued ping packet came from a first client that requested the IP address allocation or from a second client; and
allocating the IP address to the first client, if the first client is determined to have sent the reply.

19. The method of claim 18, further comprising discarding the IP address allocation request if the second client is determined to have sent the reply.

20. The method of claim 18, further comprising:
comparing an event occurrence time stored in a ping entry with an out time set in the ping packet; and
erasing the ping entry if the event occurrence time is older than the out time.

21. The method of claim 18, further comprising repeatedly determining whether the reply has been received.
